(19) United States
(12) Patent Application Publication
(10) Pub. No.: US 2021/0034988 A1
(43) Pub. Date: Feb. 4, 2021

(54) DEVICE AND METHOD FOR MACHINE LEARNING AND ACTIVATING A MACHINE

(71) Applicant: Robert Bosch GmbH, Stuttgart (DE)

(72) Inventors: Heike Adel-Vu, Stuttgart (DE); Jannik Stroetgen, Karlsruhe (DE)

(21) Appl. No.: 16/937,091

(22) Filed: Jul. 23, 2020

(30) Foreign Application Priority Data
Aug. 2, 2019 (DE) 102019211651.5

(51) Int. Cl. G06N 5/02; G06K 9/62; G06N 3/02; G06F 17/16

(52) U.S. Cl. CPC G06N 5/02; G06F 17/16; G06N 3/02; G06K 9/628

(57) ABSTRACT

A device and method for activating a machine or for machine learning or for filling a knowledge graph. Training data are made available, including texts having labels with regard to a structured piece of information. A system for classification is trained using the training data, the system for classification including an attention function that weighs individual vector representations of individual parts of a sentence as a function of weights, a classification of the sentence is determined as a function of an output of the attention function. The machine is activated in response to the input data or a knowledge graph is filled with information, i.e., expanded or built anew, in response to input data.

### CROSS REFERENCE

The present application claims the benefit under 35 U.S.C. § 119 of German Patent Application No. DE 102019211651.5 filed on Aug. 2, 2019, which is expressly incorporated herein by reference in its entirety.

### FIELD

The present invention is directed to a device and a method for machine learning and activating a machine.

### BACKGROUND INFORMATION

Methods for machine learning may use texts to train a machine to carry out actions based on a content of the text. A relation extraction is a possibility in order to extract a structured piece of information from a text. For this purpose, recurrent neural networks or convolutional neural networks may be used. For robustly activating machines or for machine learning it is desirable to further improve methods of this type.

### SUMMARY

This is achieved in accordance with example embodiment of the present invention.

In accordance with an example embodiment of the present invention, a method for activating a machine provides that in a first phase, training data are made available, the training data including texts having labels with regard to a structured piece of information, in particular concepts and entities contained in the texts or relations existing between same; in a second phase, a system for classification, in particular an artificial neural network, is trained with the aid of these training data, the system for classification including an attention function designed to weigh individual vector representations of the individual parts of a sentence as a function of their weights, a classification of the sentence being determined as a function of an output of the attention function, one of the weights for a vector representation of one of the parts of a sentence being defined by a first feature, a first weighting for the first feature, a second feature and a second weighting for the second feature, the first feature being defined as a function of a dependence tree for the sentence and the second feature being defined as a function of at least one relational argument for the sentence; and in a third phase, the machine is activated in response to input data, in particular a voice or a text input, as a function of an output signal of the system trained in this manner. A decision, according to which the machine is activated, is made by the model as a function of the input data. The decision is specific to the relational argument. In this way, it is possible to focus more on some specific parts of the sentence than on others. This significantly improves the decision and thus the activation of the machine.

In accordance with an example embodiment of the present invention, a method for filling a knowledge graph provides that in a first phase, training data are made available, the training data including texts having labels with regard to a structured piece of information, in particular concepts and entities contained in the texts or relations existing between same; in a second phase, a system for classification, in particular an artificial neural network, is trained with the aid of these training data, the system for classification including an attention function that is designed to weigh individual vector representations of individual parts of a sentence as a function of weights, a classification of the sentence being determined as a function of an output of the attention function, one of the weights for a vector representation of one of the parts of a sentence being defined by a first feature, a first weighting for the first feature, a second feature and a second weighting for the second feature, the first feature being defined as a function of a dependence tree for the sentence and the second feature being defined as a function of at least one relational argument for the sentence; and in a third phase, the knowledge graph is filled with information, in particular expanded or built anew, in response to the input data, which contain text having entities as a function of the relational arguments determined as a function of the input data, a relation between two entities of the text contained in the input data being determined as a function of the model and assigned to an edge of the knowledge graph between these entities. In this application, the knowledge graph is filled, i.e., the extracted relations are assigned among entities to edges labeled in the knowledge graph.

In accordance with an example embodiment of the present invention, a computer-implemented method for training a model, in particular an artificial neural network, provides that in a first phase training data are made available, the training data including texts having labels with regard to a structured piece of information; in a second phase, a system for classification, in particular an artificial neural network, is trained with the aid of these training data, the system for classification including an attention function designed to weigh individual vector representations of individual parts of a sentence as a function of weights, a classification of the sentence being determined as a function of an output of the attention function, one of the weights for a vector representation of one of the parts of a sentence being defined by a first feature, a first weighting for the first feature, a second feature and a second weighting for the second feature, the first feature being defined as a function of a dependence tree for the sentence and the second feature being defined as a function of at least one relational argument for the sentence. This represents a particularly effective learning method.

The first feature preferably characterizes a first distance between a word of the sentence and a first relational argument in a dependence tree for this sentence and a second distance between the word and a second relational argument in the dependence tree, a vector representation of a shortest connection between the two relational arguments in the dependence tree and/or a binary variable indicating whether or not the word is located in a shortest connection. In the sentence, the word may be a word that is a relational argument. In the sentence, the word may be a word that is not a relational argument itself. For example, in the case of the sentence “Barack Obama Sr., the father of Barack Obama, was born in 1936.” the relational argument “Barack Obama” is not located between the relational arguments “Barack Obama Sr.” and “1936” in the dependence tree. The length of the path between “Barack Obama” and “1936” is not shorter than the length of the path between “Barack Obama Sr.” and “1936”. This additionally improves the decision of the model.

It is preferably provided that the first distance is defined by a length, in particular a number of edges, of a particularly shortest path between a position of the word and of the first relational argument in the dependence tree of the sentence and/or that the second distance is defined by a length, in particular a number of edges, of an in particular shortest path between a position of the word and of the second relational argument in the dependence tree of the sentence.

The second feature preferably characterizes the relational arguments and their types.

A first vector preferably represents the first relational argument, a second vector representing the second relational argument. In this way, the model learns to consider or to ignore certain key words in the text for certain relational arguments.

A vector preferably represents the type of one of the relational arguments. In this way, the model learns to consider or to ignore certain key words in the text for certain types of relational arguments. It is thus learned, for example, that the key words “was born in” are important for persons and date specifications, but not for organizations.

In accordance with an example embodiment of the present invention, a device for activating a machine and/or for machine learning includes a processor and a memory for a model of a system for classification, in particular an artificial neural network, that are designed to carry out the example method.

Further advantageous specific embodiments result from the description below and the figures.

### BRIEF DESCRIPTION OF THE DRAWINGS

FIG. 1 shows a schematic illustration of a device for activating a machine or for machine learning in accordance with an example embodiment of the present invention.

FIG. 2 shows steps in a method for activating a machine in accordance with an example embodiment of the present invention.

FIG. 3 shows steps in a method for machine learning in accordance with an example embodiment of the present invention.

FIG. 4 shows a schematic illustration of features in accordance with an example embodiment of the present invention.

### DETAILED DESCRIPTION OF EXAMPLE EMBODIMENTS

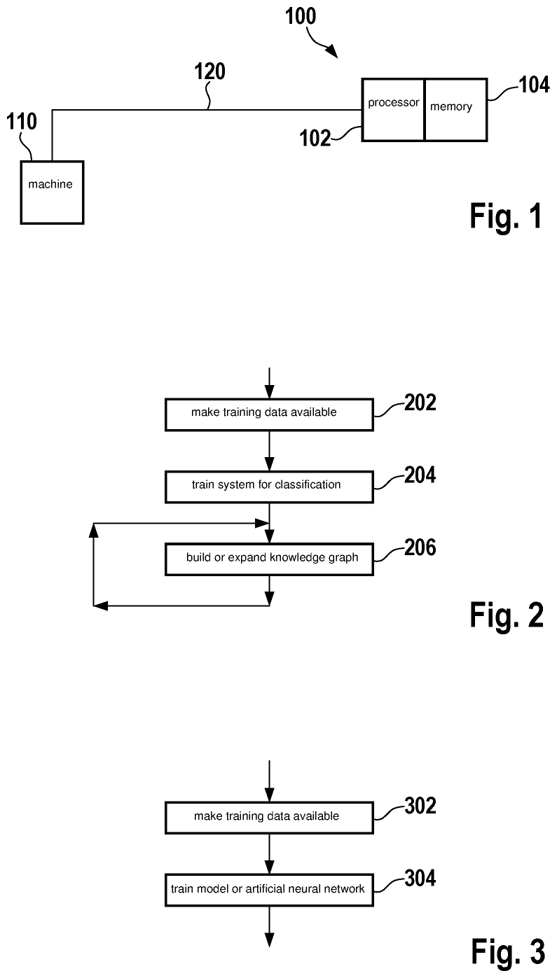

FIG. 1 illustrates parts of a device 100 for activating a machine 110 in accordance with an example embodiment of the present invention. Device 100 may be additionally or alternatively designed for machine learning.

Device 100 includes a processor 102 and a memory 104 for a model of a system for classification, in particular an artificial neural network, that are designed to carry out one of the two methods described in the following or both methods. A server or a distributed server system is preferably provided as device 100 for the purpose of training. A model trained in the training may also be transferred to a device 100, which includes a microcontroller as processor 102 and memory 104, for activating machine 110.

Machine 110 is activatable through an activation signal that may be received by device 100 via a signal line 120, when device 100 is carrying out the method described in the following for activating machine 110, in order to determine the activation signal as the output.

In a step 202, the method for activating machine 110 provides that training data are made available in a first phase.

The training data are based on digital text documents or on digital voice recordings. These are in general referred to as text inputs in the following. A conversion, connected upstream, of audio signals into text data may be provided for digital speech.

The training data include texts having labels with regard to a structured piece of information. In a first step of the neural network, vector representations are created for the texts. These vector representations are signals for the attention function.

The vector representations are, for example, determined as a function of the text inputs. Individual parts of a sentence are individual words or individual phrases from the sentences in this example.

In a step 204, a system for classification is subsequently trained with the aid of these training data in a second phase.

In the present example, the system for classification includes the model having an attention function. The model is, for example, an artificial neural network including an attention layer that is situated between an input layer and an output layer of the artificial neural network.

The attention function is designed to weigh individual vector representations of individual parts of a sentence as a function of the weights. In this way, individual parts of a sentence are weighed as a function of weights.

A classification of the entire sentence is determined as a function of an output of the attention function. The system for classification is thus designed overall to detect and extract parts of the sentence relevant for the classification.

During training, each sentence is classified as a function of the relevant parts and the weights are learned as a function of the classification result. This is described in the following for one of the weights for one of the vector representations of one of the parts of a certain sentence. The other weights are correspondingly used and learned for the other parts of this sentence in the present example.

One of the weights for a vector representation of one of the parts of a sentence is defined by a first feature, a first weight for the first feature, a second feature and a second weight for the second feature.

The first feature is defined as a function of a dependence tree for the sentence. The second feature is defined as a function of at least one relational argument for the sentence.

In the attention function, first features from a first feature group for local, i.e., token-specific, features lᵢ ∈ [symbol] ^{L}, 1≤i≤n are integrated for a sentence length n and second features from a second feature group g ∈ [symbol] ^{G} are integrated for global, i.e., sentence-specific, features. For a token i that represents a part of a sentence, for example a word, a weight αᵢ is thus defined by

$${α}_{i} = \frac{exp ( {e}_{i} )}{{\sum }_{j = 1}^{n} exp ( {e}_{j} )}$$

having the following score for token i

eᵢ=v^{T}tanh(Wₕhᵢ+W_{q}q+Wₛpᵢ^{s}+Wₒpᵢ^{o}+Wₗlᵢ+W_{g}g)

where Σⱼ₌₁ⁿ exp(eⱼ) represents a normalization.

Having the following trainable parameters of the attention function:

v ∈ [symbol] ^{A}, Wₕ ∈ [symbol] ^{A×H}, W_{q} ∈ [symbol] ^{A×H}, Wₛ ∈ [symbol] ^{A×P}, Wₒ ∈ [symbol] ^{A×P}, Wₗ ∈ [symbol] ^{A×L}, W_{g} ∈ [symbol] ^{A×G}

In this case, a dimension P of position features is defined as P:pᵢ^{s}, pᵢ^{o} ∈ [symbol] ^{P}, with pᵢ^{s} coding a distance of token i to the first relational argument and pᵢ^{o} coding a distance of token i to the second relational argument. Hyperparameters L and G are the dimensions of token-specific features lᵢ ∈ [symbol] ^{L}and of sentence-specific features g ∈ [symbol] ^{G}.

To determine a weight αᵢ of a hidden state hi, other feature characteristics are used than those used to determine a weight αⱼ for a hidden state hⱼ, where (i≠j). Hidden states hᵢ, q ∈ [symbol] ^{H} define the inputs for an attention layer. In this case, hi is the hidden state of token i and q is the last hidden state of the sentence, from which the token originates. A hidden vector of the attention layer has dimension A.

For a certain sentence, the first feature is defined as a function of a dependence tree for the sentence. The second feature for the sentence is defined as a function of at least one relational argument for the parts of the sentence.

During training, sentences are thus classified as a function of their relevant parts and the weights are learned as a function of the classification result.

The other trainable parameters of the attention function are also trained in one aspect.

The relevant parts are ascertained, for example, with the aid of a model that—based on a model according to Zhang et al. (2017) “Position-aware attention and supervised data improve slot filling” in Proceedings of the 2017 Conference on Empirical Methods in Natural Language Processing, pages 35-45, Copenhagen, Denmark, Association for Computational Linguistics—includes the following four parts:

an input layer, two layered long short-term memory layers, one attention layer and one output layer.

The attention layer from the model according to Zhang et al.

(2017) is complemented in this example by the attention layer having the described integration of different additional signals for the attention function into the attention layer, i.e., the attention weights are computed with the aid of a new function. Other input and output layers surrounding this attention layer as well as other layers that lie in-between may also be provided in deviation from the model according to Zhang et al. (2017).

In the input layer, each token i is represented by a concatenation of its word embeddings of its part-of-speech embeddings and its named-entity-tag embeddings in this example.

In the present example, the word embeddings are initialized by a previously trained 300-dimensional GloVe embedding, the other two embeddings are randomly initialized. The GloVe embedding refers to an embedding according to Pennington et. [al] “Glove: Global vectors for word representation”; Proceedings of the 2014 Conference on Empirical Methods in Natural Language Processing (EMNLP), pages 1532-1543, Doha, Qatar; Association for Computational Linguistics.

For tokens i, which are not known in the vocabulary for the input layer, an additional embedding is provided that is determined as the mean value of all of these previously trained 300-dimensional GloVe embeddings, in the present example.

In the present example, the LSTM layers are two unidirectional LSTM layers that are layered on top of one another. One output with regard to a forward propagation through the model of the last LSTM layer, of the two LSTM layers, i.e., of their hidden states, is combined with attention weights in a weighted manner for the purpose of determining a representation of entire sentences.

The output layer is a linear layer in the present example. One output of the model is generated in this example through the output layer, in that the representation of an entire sentence is included in the linear layer displaying the representation of the entire sentence on a vector that represents a number of output classes. In the present example, a SoftMax activation function is subsequently used to obtain a probability distribution across the output classes.

The relevant parts of the entire sentences are identified in this example as a function of the output classes and are subsequently classified with a long short-term memory, LSTM, for example.

The training ends, for example, when a predefined number of training data has been classified.

In a step 206, in a third phase, machine 110 is subsequently activated in response to the input data, in particular a voice or a text input, as a function of the output signal of the system trained in this manner.

A decision, according to which machine 110 is activated, is made by the model as a function of the input data through the classification.

In step 206, it may instead or additionally be provided to build a knowledge graph anew or to expand an existing knowledge graph as a function of the input data. The knowledge graph is determined in response to the input data that contain text having entities. The knowledge graph is filled with information as a function of relational arguments that are determined as a function of the input data. A relation between two entities of the text containing the input data is assigned an edge of the knowledge graph between these entities in the knowledge graph.

The relations are determined with the aid of the model in this case. The model receives a text, for example a sentence, and two entities as input data. The sentence may be, for example, “Barack Obama Sr., the father of Barack Obama, married Kezia.” The two entities may either be nodes in an existing knowledge graph or be inserted as such into a knowledge graph that already exists or is to be built anew. The entities are “Barack Obama Sr.” and “Kezia”, for example. The attention-based model is applied to these input data. In this case, the model outputs the relation “spouse_of” as the output. In the knowledge graph, an edge is inserted between the nodes “Barack Obama Sr.” and “Kezia”, carrying the label “spouse_of”.

The method is subsequently repeated in step 206 for new input data.

A computer-implemented method for training the model, in particular the artificial neural network, provides that in a step 302 training data are made available in a first phase.

The training data are made available as described in step 202, for example.

In a step 304, in a second phase, the system for classification, in particular the model or the artificial neural network, is subsequently trained with the aid of these training data in the same manner as previously described in step 204.

The method subsequently ends.

The first feature may characterize a first distance between a word of the sentence and a first relational argument in a dependence tree for this sentence and a second distance between the word and a second relational argument in the dependence tree.

The distance may be defined by a length of an in particular shortest path between a position of the first relational argument and a position of the second relational argument in the dependence tree of the sentence. The length may be defined by a number of edges in the dependence tree.

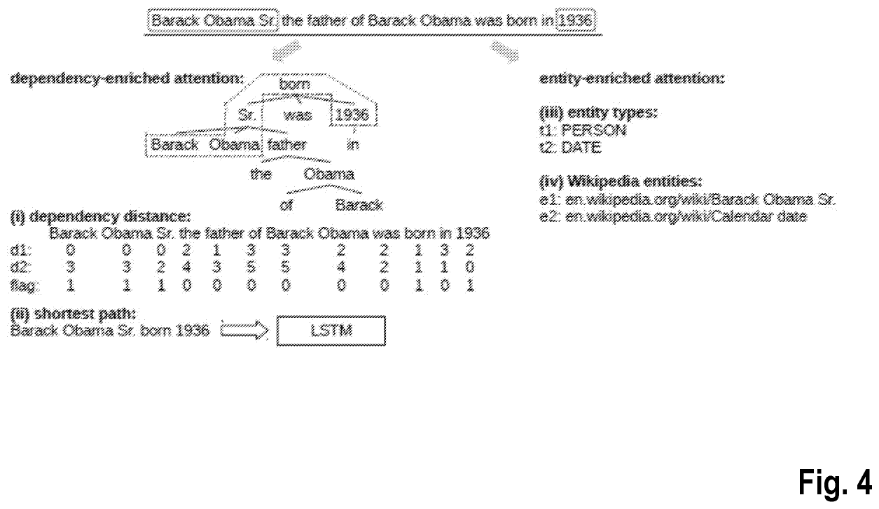

In FIG. 4, a dependence tree is illustrated by way of example for a sentence “Barack Obama Sr., the father of Barack Obama, was born in 1936.”

The dependence tree contains relational arguments that are identified according to the individual words of the sentence in FIG. 4. For the exemplary sentence, a first distance d1 is illustrated in table (i) “dependency distance” for a first part of the sentence “Barack Obama Sr.” and a second distance d2 is illustrated for a second part of the sentence “1936”. The parts of a sentence are represented by tokens that may be evaluated with the aid of the model in the same manner as previously described.

For the first feature group, a feature is illustrated in FIG. 4 that displays as a binary variable “flag”, whether a word of the sentence in the dependence tree of the sentence is located on the shortest path between the first relational argument and the second relational argument. The word is located on the shortest path, if binary variable “flag” equals 1. The word is not located on the shortest path, if binary variable “flag” equals 0.

A local vector lᵢ, which includes other characteristics of each token i, may be deduced from the first feature. Local vector lᵢ may for example include a concatenation of the vectors that represent the first features for a token i:

lᵢ =[dᵢ^{e}^{₁}; dᵢ^{e}^{₂}; fᵢ] ∈ [symbol] ^{2D+1}

where [;] refers to the concatenation.

For example, one learns from the artificial neural network, for the relevant parts of the sentence, to put less weight or no weight at all on tokens i that are not located on the shortest path.

The first feature may also characterize a shortest path between two entities. In the case of the path indicated by (ii) “shortest path”, an output vector s of an LSTM for the shortest path between the entities “Barack Obama Sr.” and “1936” represents the first feature, for example.

The second feature may characterize a type of one of the relational arguments. Exemplary types illustrated in table (iii) are “entity types”; types t₁: person and t₂: date. These may be represented as third vectors.

The second feature may also include vectors g that are computed as described in Yamada et al., 2017 “Learning distributed representations of texts and entities from knowledge base.” Transactions of the Association for Computational Linguistics, 5:397-411. These are determined based on the exemplary sources for relational arguments e₁ and e₂ that are illustrated in table (iv) “Wikipedia entities.”

With the aid of concatenation, these features may be used to create a global vector that is the same for all tokens i of one sentence:

g=[s; t₁;t₂s; e₁; e₂]

What is claimed is:

1. A method for activating a machine, comprising the following steps:
in a first phase, making training data available, the training data including texts having labels with regard to a structured piece of information, including concepts and entities contained in the texts or relations existing between the entities;
in a second phase, training a system for classification, using the training data, the system for classification including an attention function that is configured to weigh individual vector representations of individual parts of a sentence as a function of weights, a classification of the sentence being determined as a function of an output of the attention function, one of the weights for a vector representation of one of the parts of the sentence being defined by a first feature, a first weighting for the first feature, a second feature and a second weighting for the second feature, the first feature being defined as a function of a dependence tree for the sentence and the second feature being defined as a function of at least one relational argument for the sentence; and
in a third phase, activating the machine in response to input data as a function of an output signal of the trained system for classification.

2. The method as recited in claim 1, wherein the system for classification is an artificial neural network.

3. The method as recited in claim 1, wherein the input data is voice input or text input.

4. A method for filling a knowledge graph, comprising the following steps:
in a first phase, making training data available, the training data including texts having labels with regard to a structured piece of information including concepts and entities contained in the texts or relations existing between the entities;
in a second phase, training a system for classification using the training data, the system for classification including an attention function that is configured to weigh individual vector representations of individual parts of a sentence as a function of weights, a classification of the sentence being determined as a function of an output of the attention function, one of the weights for a vector representation of one of the parts of the sentence being defined by a first feature, a first weighting for the first feature, a second feature and a second weighting for the second feature, the first feature being defined as a function of a dependence tree for the sentence and the second feature being defined as a function of at least one relational argument for the sentence; and
in a third phase, filling the knowledge graph with information to expand or build anew the knowledge graph, in response to input data, the input data containing text having entities as a function of the relational arguments determined as a function of the input data, a relation between two entities of the text contained in the input data being determined as a function of the system for classification and assigned to an edge of the knowledge graph between the entities.

5. The method as recited in claim 4, wherein the system for classification is an artificial neural network.

6. A computer-implemented method for training a an artificial neural network, comprising the following steps:
in a first phase, making training data available, the training data including texts having labels with regard to a structured piece of information;
in a second phase, training the artificial neural network using the training data, the artificial neural network including an attention function that is configured to weigh individual vector representations of individual parts of a sentence as a function of weights, a classification of the sentence being determined as a function of an output of the attention function, one of the weights for a vector representation of one of the parts of the sentence being defined by a first feature, a first weighting for the first feature, a second feature and a second weighting for the second feature, the first feature being defined as a function of a dependence tree for the sentence and the second feature being defined as a function of at least one relational argument for the sentence.

7. The method as recited in claim 1, wherein the first feature characterizes a first distance between a word of the sentence and a first relational argument in a dependence tree for the sentence and a second distance between the word and a second relational argument in the dependence tree, a vector representation of a shortest connection between the first and second relational arguments in the dependence tree and/or a binary variable that indicates whether or not the word is located in the shortest connection.

8. The method as recited in claim 4, wherein the first feature characterizes a first distance between a word of the sentence and a first relational argument in a dependence tree for the sentence and a second distance between the word and a second relational argument in the dependence tree, a vector representation of a shortest connection between the first and second relational arguments in the dependence tree and/or a binary variable that indicates whether or not the word is located in the shortest connection.

9. The method as recited in claim 6, wherein the first feature characterizes a first distance between a word of the sentence and a first relational argument in a dependence tree for the sentence and a second distance between the word and a second relational argument in the dependence tree, a vector representation of a shortest connection between the first and second relational arguments in the dependence tree and/or a binary variable that indicates whether or not the word is located in the shortest connection.

10. The method as recited in claim 7, wherein the first distance is defined by a length a number of edges of a shortest path between a position of the word and of the first relational argument in the dependence tree of the sentence and/or that the second distance is defined by a number of edges of a shortest path between a position of the word and of the second relational argument in the dependence tree of the sentence.

11. The method as recited in claim 1, wherein the second feature characterizes the at least one relational arguments and their types.

12. The method as recited in claim 1, wherein a first vector represents the first relational argument, a second vector represents the second relational argument.

13. The method as recited in claim 12, wherein a vector represents the type of one of the relational arguments.

14. A device for activating a machine, comprising:
a processor; and
a memory a model of a system for classification;
wherein the device is configured to:
in a first phase, make training data available, the training data including texts having labels with regard to a structured piece of information, including concepts and entities contained in the texts or relations existing between the entities;
in a second phase, train the system for classification, using the training data, the system for classification including an attention function that is configured to weigh individual vector representations of individual parts of a sentence as a function of weights, a classification of the sentence being determined as a function of an output of the attention function, one of the weights for a vector representation of one of the parts of the sentence being defined by a first feature, a first weighting for the first feature, a second feature and a second weighting for the second feature, the first feature being defined as a function of a dependence tree for the sentence and the second feature being defined as a function of at least one relational argument for the sentence; and
in a third phase, activate the machine in response to input data as a function of an output signal of the trained system for classification.

15. A non-transitory machine-readable memory medium on which is stored a computer program for activating a machine, the computer program, when executed by a computer, causing the computer to perform the following steps:
in a first phase, making training data available, the training data including texts having labels with regard to a structured piece of information, including concepts and entities contained in the texts or relations existing between the entities;
in a second phase, training a system for classification, using the training data, the system for classification including an attention function that is configured to weigh individual vector representations of individual parts of a sentence as a function of weights, a classification of the sentence being determined as a function of an output of the attention function, one of the weights for a vector representation of one of the parts of the sentence being defined by a first feature, a first weighting for the first feature, a second feature and a second weighting for the second feature, the first feature being defined as a function of a dependence tree for the sentence and the second feature being defined as a function of at least one relational argument for the sentence; and
in a third phase, activating the machine in response to input data as a function of an output signal of the trained system for classification.
